(19) United States
(12) Patent Application Publication
(10) Pub. No.: US 2010/0225853 A1
(43) Pub. Date: Sep. 9, 2010

(54) REFLECTIVE COLOR-CHANGING LIQUID CRYSTAL DISPLAY

(75) Inventors: Chih-Yuan Wang, Taichung County (TW); Hsien-Wei Chiang, Taipei City (TW); Wen-Chun Wang, Taichung City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: WINTEK CORPORATION, Taichung (TW)

(21) Appl. No.: 12/716,260

(22) Filed: Mar. 2, 2010

(30) Foreign Application Priority Data
Mar. 3, 2009 (TW) 98106885

(51) Int. Cl. G02F 1/1334

(52) U.S. Cl. 349/86

(57) ABSTRACT

A reflective color-changing liquid crystal display including a first substrate, a second substrate parallel thereto, a first color-changing liquid crystal mixture layer between the two substrates, a first electrode layer and a second electrode layer disposed is provided. The color-changing liquid crystal mixture layer includes a plurality of liquid crystal molecules, a chiral dopant and a polymer mixture. The liquid crystal molecules and the chiral dopant are scattered in a solidified structure of the polymer mixture. The first electrode layer is disposed between the first substrate and the first color-changing liquid crystal mixture layer. The second electrode is disposed between the second substrate and the first color-changing liquid crystal mixture layer. The first color-changing liquid crystal mixture layer is suitable for reflecting a first reflective light with a wavelength changing with a first electric field produced between the first electrode layer and the second electrode layer.

### CROSS-REFERENCE TO RELATED APPLICATION

This application claims the priority benefit of Taiwan application' serial no. 98106885, filed on Mar. 3, 2009. The entirety of the above-mentioned patent application is hereby incorporated by reference herein and made a part of specification.

### BACKGROUND OF THE INVENTION

1. Field of the Invention

The present invention generally relates to a liquid crystal display, in particular, to a reflective color-changing liquid crystal display.

2. Description of Related Art

The cholesteric liquid crystal displays are almost reflective liquid crystal displays, wherein the cholesteric liquid crystal materials are considered as the material of the reflective layers. Furthermore, the full-color cholesteric liquid crystal displays have been provided. The most common full-color cholesteric liquid crystal displays use a stack of the liquid crystal material layers with three fundamental colors, such as red, green and blue respectively to achieve the function of full-color display. Alternatively, the liquid crystal material layers with the three fundamental colors, such as red, green, and blue are respectively disposed in different pixel structures so as to accomplish the effect of full-color display.

If it is adopted to stack the liquid crystal material layers with three fundamental colors, such as red, green and blue so as to achieving the full-color display effect, the thickness of the cholesteric liquid crystal display is incapable of being decreased. In another way, if the liquid crystal material layers with the three fundamental colors, such as red, green, and blue are respectively disposed in different pixel structures, the reflective effect and the display contrast of the cholesteric liquid crystal display are significantly dropped. Therefore, the reflective liquid crystal displays configured with such designs still have many unresolved problems in the aspect of the full-color display technology.

### SUMMARY OF THE INVENTION

Accordingly, the present invention is directed to a reflective color-changing liquid crystal display, wherein the color-changing liquid crystal mixture layer is suitable for reflecting the visible light with different wavelengths under different electric fields so as to achieve the multi-color display effect or the full-color display effect.

The present invention is directed to a reflective color-changing liquid crystal display including a first substrate, a second substrate, a first color-changing liquid crystal mixture layer, a first electrode layer and a second electrode layer. The second substrate is parallel to the first substrate and the first liquid crystal mixture layer is disposed therebetween. The first color-changing liquid crystal mixture layer includes a plurality of liquid crystal molecules, a chiral dopant and a polymer mixture. The liquid crystal molecules and the chiral dopant are scattered in a solidified structure of the polymer mixture. The first electrode layer is disposed between the first substrate and the first color-changing liquid crystal mixture layer. The second electrode is disposed between the second substrate and the first color-changing liquid crystal mixture layer. The first color-changing liquid crystal mixture layer is suitable for reflecting a first reflective light with a wavelength changing with a first electric field produced between the first electrode layer and the second electrode layer.

In an embodiment of the present invention, the reflective color-changing liquid crystal display further includes a third substrate, a second color-changing liquid crystal mixture layer, a third electrode layer and a fourth electrode layer. The third substrate is disposed at a side of the second substrate away from the first color-changing liquid crystal mixture layer. The second color-changing liquid crystal mixture layer is disposed between the third substrate and the second substrate. The third electrode layer is disposed between the third substrate and the second color-changing liquid crystal mixture layer. The fourth electrode layer is disposed between the second substrate and the second color-changing liquid crystal mixture layer. The second color-changing liquid crystal mixture layer is apt to reflect a second reflective light and a wavelength of the second reflective light changes with a second electric field produced between the third electrode layer and the fourth electrode layer. Still other embodiments of the reflective color-changing liquid crystal displays are provided in the following contents.

Accordingly, the liquid crystal molecules, the chiral dopant and the polymer mixture are mixed to form the color-changing liquid crystal mixture layer suitable for reflecting reflective lights with different colors under different electric fields. Thus, the reflective color-changing liquid crystal display of the present invention can achieve the multi-color display effect without stacking three liquid crystal layers. That is to say, the reflective color-changing liquid crystal display compiles the requirement of the thinner thickness. Certainly, the design of disposing different liquid crystal layers with different colors in different pixels is not necessarily adopted in the reflective color-changing liquid crystal display of the present invention, and therefore the reflective effect of the reflective color-changing liquid crystal display of the present invention is improved.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates a reflective color-changing liquid crystal display according to the first embodiment of the present invention.

FIG. 2 illustrates a reflective color-changing liquid crystal display according to the second embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

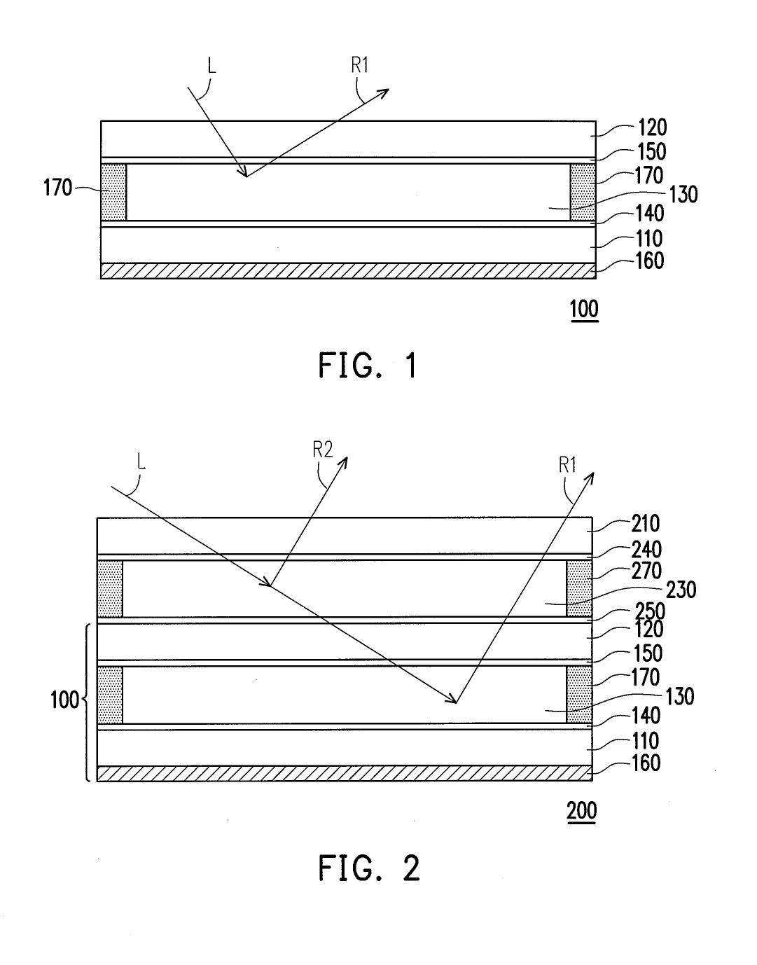

FIG. 1 illustrates a reflective color-changing liquid crystal display according to the first embodiment of the present invention. Referring to FIG. 1, the reflective color-changing liquid crystal display 100 includes a first substrate 110, a second substrate 120, a first color-changing liquid crystal mixture layer 130, a first electrode layer 140 and a second electrode layer 150. The second substrate 120 is parallel to the first substrate 110 and the first color-changing liquid crystal mixture layer 130 is disposed between the first substrate 110 and the second substrate 120. The first electrode layer 140 is disposed between the first substrate 110 and the first color-changing liquid crystal mixture layer 130, and the second electrode layer 150 is disposed between the second substrate 120 and the first color-changing liquid crystal mixture layer 130. The first color-changing liquid crystal mixture layer 130 is suitable for reflecting a first reflective light R1, and a wavelength of the first reflective light R1 changes with a first electric field produced between the first electrode layer 140 and the second electrode layer 150.

The first color-changing liquid crystal mixture layer 130 includes a plurality of liquid crystal molecules, a chiral dopant, and a polymer mixture, wherein the liquid crystal molecules and the chiral dopant are scattered in a solidified structure of the polymer mixture. Generally, the liquid crystal molecules of the first color-changing liquid crystal mixture layer are twisted, inclined or bended through the effect of the first electric field. In the present embodiment, the liquid crystal molecules are influenced by not only the first electric field but also the solidified structure of the polymer mixture. Therefore, the liquid crystal molecules of the first color-changing liquid crystal mixture layer 130 may represent in different attitudes when the value of the first electric field changes.

In particular, the reflective light R1 which is the reflection of the light L incidents into the first color-changing liquid crystal mixture layer 130 may have different wavelengths through the effect of the first electric field and the solidified structure of the polymer mixture. Thus, the reflective color-changing liquid crystal display 100 is capable of having multi-color display effect. In addition, in a certain first electric field, the first color-changing liquid crystal mixture layer 130 may not provide the effect of reflection to produce the first reflective light R1, but admit the light L to pass through the first color-changing liquid crystal mixture layer 130 directly.

In the present embodiment, the wavelength of the first reflective light R1 changes from 500 nm to 750 nm, from 500 nm to 600 nm, from 400 nm to 500 nm or other ranges. That is to say, the first color-changing liquid crystal mixture layer 130 is apt to provide the effect of reflection to produce the first reflective light R1 with different colors. When the reflective liquid crystal display 100 displays, it is only required to modulate the value of the first electric field between the first electrode layer 140 and the second electrode layer 150 in different area so as to achieve the full-color display effect. It is noted that the first electrode layer 140 or the second electrode layer 150 can be a pixel electrode array for rendering the values of the first electric field between the first electrode layer 140 and the second electrode layer 150 in different area dissimilar. As a whole, the reflective color-changing liquid crystal display 100 of the present embodiment does not require to stack numbers of liquid crystal material layers or to package kinds of liquid crystal material layers into different pixels so as to accomplish the full-color or multi-color display effect. Accordingly, the types of the liquid crystal materials used in the reflective color-changing liquid crystal display 100 of the present embodiment is less and then the thickness of the reflective color-changing liquid crystal display 100 is further thin.

In addition, the first color-changing liquid crystal mixture layer 130 can maintain rather good reflectivity. Therefore, the reflective color-changing liquid crystal display 100 performs good display quality. According to the testing result, the reflective color-changing liquid crystal display 100 may timely modulate the wavelength of the first reflective light R1 reflected by the first color-changing liquid crystal mixture layer 130 without the application of high driving voltage. Namely, the reflective color-changing display 100 can have multi-color or even full-color display effect without consuming large quantity of power.

Specifically, the polymer mixture is polymerized from a starting material. In one embodiment, the starting material includes a plurality of monomers, a plurality of oligomers, and an initiator. Herein, the monomers and the polymers may have single functional group or multi functional group respectively. Substantially, the starting material further includes a wetting agent, a levelling agent, a curing agent, a promoter, an accelerator, etc. When the reflective color-changing liquid crystal display 100 is manufactured, the starting material, the liquid crystal molecules and the chiral agent are, for example, filled into the space between the first substrate 110 and the second substrate 120. Then, a solidification process is processed to render the starting material polymerized and solidified into the polymer mixture. Herein, the method for solidifying the starting material is a thermal solidified method or a photo solidified method, wherein the starting material is a thermal solidified-able material or a photo solidified-able material correspondingly.

The wetting agent is apt to improve the adhesive quality among the molecules of the starting material and change the surface tension of the starting material, and thus the starting material can evenly distributed on the surface of the first substrate 110 or the second substrate 120. The levelling agent is conducive to render the starting material a flat surface on the first substrate 110 or the second substrate 120. The curing agent conduces to solidify the polymer mixture. The promoter or the accelerator is conducive to accelerate the polymerization rate of the starting material.

Furthermore, the liquid crystal molecules are, for example, a plurality of nematic liquid crystal molecules, a plurality of cholesteric liquid crystal molecules, a plurality of chiral liquid crystal molecules or a combination thereof. The chiral agent is a cyano series chiral agent, a cholesteryl nonanoate, a nonracemic, a macromolecular helicity, a azobenzenes chiral agent, a ZLI series chiral agent, a binaphthalene chiral agent, or a bipolar chiral agent. Herein, the ZLI series chiral agent includes the products which are produced by Merk & Co., Inc. and have the ZLI series number such as ZLI-4571 (S-1011), ZLI-4572 (R-1011), ZLI-0811 (S-811), and the like. In the present embodiment, the first substrate 110 and the second substrate 120 can both be transparent substrates. The ordinary material of the transparent substrate is glass, polyethylene terephthalate (PET), polyethersulfone (PES), polyimide (PI), etc. The material of the first electrode layer 140 and the second electrode layer 150 are transparent conductive materials, such as indium tin oxide (ITO), indium zinc oxide (IZO), aluminium zinc oxide (AZO), zinc oxide or tin oxide.

In addition, the reflective color-changing liquid crystal display 100 further includes a setting layer disposed on a side of the first substrate away from the color-changing liquid crystal mixture layer 130. The setting layer is a reflective material layer or a dark material layer. The setting layer 160 is the reflective material layer so as to provide a reflection to more efficiently reflect the incident light L. That is, the configuration of the setting layer 160 is conducive to improve the light reflectivity of the reflective color-changing liquid crystal display 100. Certainly, the reflective color-changing liquid crystal display 100 may further includes a plurality of spacers 170 disposed between the first substrate 110 and the second substrate 120 to maintain the gap between the first substrate 110 and the second substrate 120, and the height of the spacers is, for example, smaller than or equal to 50 μm.

Besides, the reflective color-changing liquid crystal display 100 can further include a coloring material for rendering the image color displayed by the reflective color-changing liquid crystal display 100 more perfect. The coloring material is a pigment or a dye adding in the first color-changing liquid crystal mixture layer 130, for example. In one embodiment, the first reflective light R1 reflected by the first color-changing liquid crystal mixture layer 130 may represent in orange-red color in long wavelength, and a red coloring material may be added into the first color-changing liquid crystal mixture layer 130 in the reflective color-changing liquid crystal display 100. Therefore, the reflective color-changing liquid crystal display 100 can display a red image correctly without orange-color shifting. In another word, the addition of the coloring material conduces to advance the correctness of the image color displayed by the reflective color-changing liquid crystal display 100.

FIG. 2 illustrates a reflective color-changing liquid crystal display according to the second embodiment of the present invention. Referring to FIG. 2, the reflective color-changing liquid crystal display 200 is evolved from the reflective color-changing liquid crystal display 100, wherein the reflective color-changing liquid crystal display 200 further comprises a second color-changing liquid crystal mixture material. Therefore, besides the structure design and the elements of the reflective color-changing liquid crystal display 100, the reflective color-changing liquid crystal display 200 further has a third substrate 210, a second color-changing liquid crystal mixture layer 230, a third electrode layer 240 and a fourth electrode layer 250.

The third substrate 210 is disposed at a side of the second substrate 120 away from the first color-changing liquid crystal mixture layer 130. The second color-changing liquid crystal mixture layer 230 is disposed between the third substrate 210 and the second substrate 120. The third electrode layer 240 is disposed between the third substrate 210 and the second color-changing liquid crystal mixture layer 230. The fourth electrode layer 250 is disposed between the second substrate 120 and the second color-changing liquid crystal mixture layer 230. The second color-changing liquid crystal mixture layer 230 is apt to reflect a second reflective light R2 and a wavelength of the second reflective light R2 changes with a second electrode field produced between the third electrode layer 240 and the fourth electrode layer 250.

In another word, the second color-changing liquid crystal mixture layer 230 is formed by the material similar to the material of the first color-changing liquid crystal mixture layer 130, and thus the second color-changing liquid crystal mixture layer 230 can provide a reflection to produce a second reflective light R2 with different wavelengths when the second electric field changes. The wavelength of the second reflective light R2 changes from 500 nm to 750 nm, for example. Surely, the wavelength of the second reflective light R2 may change from 500 nm to 600 nm or other ranges.

It is noted that the wavelengths of the first reflective light R1 and the second reflective light R2 are capable of being modulated and the range of the wavelengths preferably contains the whole rang of the visible light wavelength. Therefore, the reflective color-changing liquid crystal display 200 can display a full-color image without disposing a third color-changing liquid crystal mixture layer. In particular, a coloring material may be added into at least one of the first color-changing liquid crystal mixture layer 130 and the second color-changing liquid crystal mixture layer 230 for letting the image color displayed by the reflective color-changing liquid crystal display 200 be more saturated. As described in the first embodiment, the coloring material may be a pigment or a dye.

In the present embodiment, the third substrate may be a transparent substrate. The materials of the third electrode layer 240 and the fourth electrode layer 250 are transparent conductive materials. Certainly, the reflective color-changing liquid crystal display 200 can further includes a plurality of spacers 270 disposed between the third substrate 210 and the second substrate 120. The height of the spacers 170 and the spacers 270 is substantially smaller than or equal to 50 μm. Specifically, the spacers 170 and the spacers 270 are ball spacers, photoresist spacers, polymer spacers, etc. The shape of the spacers 170 and the spacers 270 is designed as needed. The spacers 170 may be connected with each other or independent from each other and the spacers 270 may also be connected with each other or independent from each other.

As described above, in the reflective color-changing liquid crystal display according to the present invention, the color-changing liquid crystal mixture layer is apt to provide the reflection to produce the reflective light with different wavelengths under various electric fields. Thus, the reflective color-changing liquid crystal display only adopts one single liquid crystal mixture layer to perform the multi-color display effect. Accordingly, the thickness of the reflective color-changing liquid crystal display is effectively decreased and the material cost and the types of the color-changing liquid crystal mixture layer can also be reduced. In addition, the color-changing liquid crystal mixture layer according to the present invention has good reflectivity and renders the reflective color-changing liquid crystal display to perform good display effect.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A reflective color-changing liquid crystal display comprising:
a first substrate;
a second substrate parallel to the first substrate;
a first color-changing liquid crystal mixture layer disposed between the first substrate and the second substrate, and the first color-changing liquid crystal mixture layer including a plurality of liquid crystal molecules, a chiral dopant and a polymer mixture, wherein the liquid crystal molecules and the chiral dopant scattered in a solidified structure of the polymer mixture;
a first electrode layer disposed between the first substrate and the color-changing liquid crystal mixture layer; and
a second electrode layer disposed between the second substrate and the first color-changing liquid crystal mixture layer, wherein the first color-changing liquid crystal mixture is apt to reflect a first reflective light and a wavelength of the first reflective light changes with a first electric field produced between the first electrode layer and the second electrode layer.

2. The color-changing liquid crystal display according to claim 1, wherein a wavelength of the first reflective light changes substantially from 500 nm to 750 nm.

3. The color-changing liquid crystal display according to claim 1, wherein a wavelength of the first reflective light changes substantially from 500 nm to 600 nm.

4. The color-changing liquid crystal display according to claim 1, wherein a wavelength of the first reflective light changes substantially from 400 nm to 500 nm

5. The color-changing liquid crystal display according to claim 1, further comprising a setting layer disposed at a side of the first substrate away from the color-changing liquid crystal mixture layer, wherein the setting layer is a reflective material layer or a dark material layer.

6. The color-changing liquid crystal display according to claim 1, wherein the polymer mixture is formed by a polymerization of a starting material.

7. The color-changing liquid crystal display according to claim 6, wherein the starting material includes a plurality of monomers, a plurality of oligomers, and an initiator.

8. The color-changing liquid crystal display according to claim 7 wherein the starting material further includes a wetting agent and a levelling agent.

9. The color-changing liquid crystal display according to claim 7, wherein the starting material further includes curing agent.

10. The color-changing liquid crystal display according to claim 7, wherein the starting material further includes a promoter or an accelerator.

11. The color-changing liquid crystal display according to claim 6, wherein the starting material is a thermal solidified-able material or a photo solidified-able material.

12. The color-changing liquid crystal display according to claim 1, further comprising a coloring material added in the first color-changing liquid crystal mixture layer, wherein the coloring material is a pigment or a dye.

13. The color-changing liquid crystal display according to claim 1, wherein the liquid crystal molecules are a plurality of nematic liquid crystal molecules, a plurality of cholesteric liquid crystal molecules, a plurality of chiral liquid crystal molecules or a combination thereof.

14. The color-changing liquid crystal display according to claim 1, wherein the chiral agent is a cyano series chiral agent, a cholesteryl nonanoate, a nonracemic, a macromolecular helicity, a azobenzenes chiral agent, a ZLI series chiral agent, a binaphthalene chiral agent, or a bipolar chiral agent.

15. The color-changing liquid crystal display according to claim 1, further comprising a plurality of spacers disposed between the first substrate and the second substrate, wherein a height of the spacers is smaller than or equal to 50 μm.

16. The color-changing liquid crystal display according to claim 1, further comprising:
a third substrate disposed at a side of the second substrate away from the first color-changing liquid crystal mixture layer;
a second color-changing liquid crystal mixture layer disposed between the third substrate and the second substrate;
a third electrode layer disposed between the third substrate and the second color-changing liquid crystal mixture layer; and
a fourth electrode layer disposed between the second substrate and the second color-changing liquid crystal mixture layer, wherein the second color-changing liquid crystal mixture layer is apt to reflect a second reflective light and a wavelength of the second reflective light changes with a second electrode field produced between the third electrode layer and the fourth electrode layer.

17. The color-changing liquid crystal display according to claim 16, wherein a wavelength of the second reflective light changes substantially from 500 nm to 750 nm.

18. The color-changing liquid crystal display according to claim 16, wherein a wavelength of the second reflective light changes substantially from 500 nm to 600 nm.

19. The color-changing liquid crystal display according to claim 16, further comprising a coloring material added in at least one of the first color-changing liquid crystal mixture layer or the second color-changing liquid crystal mixture layer, wherein the coloring material is a pigment or a dye.

20. The color-changing liquid crystal display according to claim 16, further comprising a plurality of spacers disposed between the third substrate and the second substrate, wherein a height of the spacers is smaller than or equal to 50 μm.
